(19) United States
(12) Patent Application Publication
(10) Pub. No.: US 2025/0368064 A1
(43) Pub. Date: Dec. 4, 2025

(54) ANGLED CHARGING ADAPTER FOR UNI-DIRECTIONAL AND BIDIRECTIONAL EV CHARGING CABLES

(71) Applicant: Gravity, Inc., New York, NY (US)

(72) Inventors: Shivam Dehinwal, Thousand Oaks, CA (US); Peter Delioussine, Newbury Park, CA (US)

(73) Assignee: Gravity, Inc., New York, NY (US)

(21) Appl. No.: 19/219,540

(22) Filed: May 27, 2025

Related U.S. Application Data
(60) Provisional application No. 63/653,082, filed on May 29, 2024.

(51) Int. Cl. B60L 53/16

(52) U.S. Cl. CPC B60L 53/16

(57) ABSTRACT

The present invention provides am angled charging adapter, such as 90 degress, that is attached to the free plug end of an EV charging cable to limit the horizontal protrusion of the charge cable from the vehicle inlet and reduce strain of the physical interconnection of the charging cable to the EV. This is particularly useful to accomodate situations where a charging station is on an opposite side of the charging port of the EV and where the charging cable must be routed over the top of the vehicle or around a side of the vehicle to reach the charging port. Thus, with the adapter, the stain of the interconnection of the charging cable to the EV is reduced.

### CROSS-REFERENCE TO RELATED APPLICATION

This patent document claims priority to earlier filed U.S. Provisional Patent Application Ser. No. 63/653,082, filed May 29, 2024, the entire contents of which are incorporated herein by reference.

### BACKGROUND OF THE INVENTION

The present invention relates generally to the field of the automotive, energy and energy storage sectors. In particular, the present invention relates to the charging of electric vehicles (EVs), utilizing charging cables and connectors, namely, the connector interface between the charging cable of an electric vehicle charging system and the electric vehicle itself, via its charging socket, for the purpose of charging the electric vehicle.

By way of background, the adoption of electric vehicles (EVs) continues to increase year after year, but several limiting factors remain, one of which is the high cost and the complexity of building out the necessary charging infrastructure to support as wide a range of EV users and electric vehicles so they may be charged in a fast and convenient way.

However, in the current industry, there are problems associated with prior art charging equipment as to the manner and use in certain locations and environments. More specifically, currently, on street parking, large public parking structures, and parking lots, provide a charger, such as a DC fast charger or an AC charger for each individual parking spot. Alternatively, the charging equipment may be located remotely from the location of the charging cable at the given charging parking spots. Commonly, in known charging systems, EV chargers are mounted laterally next to the vehicle parking spot where the charger has size, configuration and location available. Therefore, there may be a wide range of physical layout and configuration options of the EV charger relative to the location of the electric vehicle to be charged. Since the location of a charging port on the EV can be in different locations on the vehicle, there are further challenges in optimizing the EV charging experience for the user.

Thus, for example, an EV charger might be on the curb adjacent to the parking space, not in the street, and therefore close to the side of vehicle rather than the front or rear of the vehicle. As a result, the EV charging system, could be located on any one of the many sides of the vehicle depending on the location and orientation of the parked vehicle relative to the charging station, and the charging port on the vehicle can be at many different locations depending on the make and model of the EV (such as driver side front, driver side back, passenger side front, passenger side back, and the like). Thus, the charging cable and the charging adapter connected on the free end thereof may be on the same side of the charging port of the vehicle which would enable a direct path of the charging cable from the charging station to the charging port of the vehicle, although this direct path may cross over the public/pedestrian right of way, such as a side walk, thus creating an inconvenient obstruction and/or a dangerous tripping hazard.

Furthermore, the charging port 12 of the EV 14 may end up being located on the opposite side of the vehicle 14 relative to the charging station 16 which presents a more challenging environment 10 to carry out the charging operation, as can be seen in FIG. 1. In this case, for example, the charging cable 18 and the adapter 20 on the free end thereof, as in FIG. 2, must be routed over the top of the EV 14 to then connect to the charging port 12 on the EV 14. As in FIG. 2, the male free end 22 of the charging adapter 20 is typically at an angle A, such as 60 degrees, relative to the main body 24 of the adapter 20. Thus, as in prior art FIG. 1, when it is plugged into a vehicle 14 where the charging station 16 is on the opposite side of the charging port 12 of the vehicle 14, the charging cable 18 protrudes laterally from the vehicle resulting in an undesirable and awkward positioning of the cable 18 while it is connected to the EV 14 while it is charging. This adds undesirable strain on the interconnection of the charging cable with the connector/adapter on the free end thereof at location X. While a DC CCS 1 adapter plug 20 is shown in FIG. 2, this problem persists for essentially all charging cables regardless of the type of port 20 on the end thereof, be it a CCS 2, NACS (Tesla) or other plug type.

This problem is further exacerbated because EVs require many amps of current into cars for fast charging. These cables are stiff and often have a large bend radius that creates friction in the user experience because the user must loop the cable to align the charging gun adapter with the charging port of the car. The problem is made worse when parking spaces are narrow, or the charge port is on the traffic side. As a result, it is very common for EV charging cables in those environmental configurations to be particularly undesirable and they can create undesirable obstructions into neighboring parking spaces and/or hazards for oncoming traffic or within pedestrian walkways.

Also, in the case of bidirectional charging via the charging cable, there is a requirement for placing a fuse in very close proximity to the vehicle socket inlet, which is a requirement that cannot be satisfied with including fusing within the charging unit.

Furthermore, there are significant safety concerns when the vehicle is plugged into the charge cable because the vehicle cannot be driven away. In the case of danger, such as while the driver is in the EV and is approached by a suspicious person, or any other hazard that precludes getting out of the vehicle and pulling out the charge cable.

Therefore, there is a need to avoid this awkward positioning of the EV charging cable in all charging environments, and especially such environments where the charging station is on the opposite side of the vehicle that has the EV charging port.

There is a need to make curbside charging, when the vehicle is parallel parked next to teh curb with the charge port on the driver side, more compact laterally and safer for all cases namely when thick and rigid EV charging cables are used.

Therefore, there is a need for an EV charging cable and adapter to better accommodate the connection to the vehicle, especially in situations and configurations where the EV charging cable is routed over an EV,

There is yet another need to reduce the amount of bending of the EV cable during the EV charging operation.

There is a need to make it easier to plug in a charging cable to an EV, particularly when the EV is location in a difficult and cumbersome location relative to the charging cable.

There is therefore a need for an adapter for a charging cable that is easy to grip and simple to connect to an EV.

There is further need for an adapter with an embedded fuse that to protect the flow of power from the vehicle back through the charging unit.

When there is a dangerous situation near the EV, there is a need for the EV to be driven away immediately and have cable quickly disconnect from the vehicle on its own, and to optimally break apart, to avoid the driver having to take the time to manually disconnect the charging cable from the vehicle.

### SUMMARY OF THE INVENTION

The present invention provides a right-angled charging adapter that is attached at the free plug end of the EV charging cable to provide a smoother and less tensioned path of the charge cable when connected to the vehicle. For example, the present invention is particularly useful to better accomodate situations where the EV charging station is on the opposite side of the charging port of the EV itself and, for example, where the charging cable must be routed over the top of the vehicle or around a side of the vehicle to reach the charging port. With the right-angle adapter of the present invention, such smoother and less tensioned charge cable path is provided. The present invention has the following unique features, as outlined below.

As to the connection of the adapter to the plug end of the charging cable, the geometry and surface finish of the right angled adapter is configured and arranged to have a strong connection to the free plug end of the charging cable while having low mating force and separation force for a comfortable connection experience.

The adapter of the present invention provides additional electronic circuitry for additional functionality, such as fusing within the adapter itself.

The present invention also provides a unique quick disconnect feature. For example, in case of an emergency when the driver needs to move the car during the charging operation, the right-angled connector is configured to split into parts to permit safe disconnection of the charging cable from the EV.

The right-angled adapter of the present invention is easy to grip by the user to facilitate the user's interaction and handling of the EV charging cable during the charging operation.

The adapter of the present invention connects to the plug end of the charging cable handle. The geometry and surface finish of the right-angled adapter is carefully configured to have a strong connection while having low mating force and separation force for a comfortable connection experience.

The connector of the present invention preferably has bidirectional fusing. More specifically, the right angle connector may include a fuse directly therein to limit the flow of power from the vehicle to the charging unit. This fuse may control the flow to the vehicle, from the vehicle, or both.

This present invention enables a more efficient and optimized connection between the charging cable the EV itself thereby optimize the space around the EV and within the given charging station area while making the process of charging the EV easier regardless of the make, model and location of the charging port on the EV.

### BRIEF DESCRIPTION OF THE DRAWING FIGURES

Further advantages, features and possible applications of the present invention are shown and described in the accompanying drawing figures.

FIG. 1 shows a prior art view of a common charging cable adapter that is connected to a charging port of an EV, where the charging port of the EV is on the opposite side of the vehicle compared to the charging station;

FIG. 2 shows a prior art CCS 1 DC plug that is commonly used as an interface for interconnecting a charging cable to an EV;

FIG. 3 shows use of the right-angled charging adapter of the present invention connected to the plug end of a charging cable to provide a right-angled optimized interconnection to an EV;

FIG. 4 shows the right-angled charging adapter of the present invention being held in a user's hand before interconnection to the plug free end of the charging cable;

FIG. 5 shows a top perspective view of the right-angled charging adapter of the present invention with a female CCS 1 DC port on one end and a male NACS port on the opposing end;

FIG. 6 is a side elevational view of the adapter of FIG. 5;

FIG. 7 is a top view of the adapter of FIG. 5;

FIG. 8 is a top perspective view of the adapter of FIG. 5 with the outer housing shown in shadow for illustration purposes only;

FIG. 9 is a bottom perspective view of the adapter of FIG. 5 with the outer housing shown in shadow for illustration purposes only;

FIG. 10 is partial a cross-sectional view through the line 10-10 of FIG. 5;

FIG. 11 is a cross-sectional view through the line 11-11 of FIG. 7;

FIG. 12 is a cross-sectional view through the line of 12-12 of FIG. 7;

FIG. 13 is a cross-sectional view through the line 13-13 of FIG. 7;

FIG. 14 is a top perspective view of the right-angled adapter of the present invention of FIG. 5 with the outer housing removed for illustration purposes;

FIG. 15 is a bottom perspective view of the right-angled adapter of the present invention of FIG. 5 with the outer housing removed for illustration purposes;

FIG. 16 is a further a bottom perspective view of the right-angled adapter of the present invention of FIG. 5 with the outer housing and other components removed for illustration purposes to show the location of the busbars for the power pins;

FIG. 17 shows a top perspective view of the right-angled adapter of the present invention of FIG. 5 with the outer housing and other components removed for illustration purposes to show the location of the busbars for the power pins;

FIG. 18 shows a alternate top perspective view of the right-angled adapter of the present invention of FIG. 5 with the outer housing and other components removed for illustration purposes to further show the location of the busbars for the power pins;

FIG. 19 shows a front view of the right-angled adapter of the present invention of FIG. 5 with the outer housing and other components removed for illustration purposes to show the location of the busbars for the power pins;

FIG. 20 shows a rear view of the right-angled adapter of the present invention of FIG. 5 with the outer housing and other components removed for illustration purposes to show the location of the busbars for the power pins;

FIG. 21 shows a right side elevational view of the right-angled adapter of the present invention of FIG. 5 with the outer housing and other components removed for illustration purposes to show the location of the busbars for the power pins;

FIG. 22 shows a top view of the right-angled adapter of the present invention of FIG. 5 with the outer housing and other components removed for illustration purposes to show the location of the busbars for the power pins;

FIG. 23 shows a bottom view of the right-angled adapter of the present invention of FIG. 5 with the outer housing and other components removed for illustration purposes to show the location of the busbars for the power pins;

FIG. 24 shows the left busbar for the left power pin of the adapter of FIG. 5;

FIG. 25 shows the right busbar for the right power pin of the adapter of FIG. 5;

FIG. 26 shows a top perspective view of the left busbar and the right busbar, with respective power pins, nested with insulative material removed for illustration purposes;

FIG. 27 is a front view of the busbars and power pins of FIG. 26;

FIG. 28 is a bottom rear perspective view of the busbars and power pins of FIG. 26;

FIG. 29 is a left side elevational view of the busbars and power pins of FIG. 26;

FIG. 30 is a top perspective view of the busbars and power pins of FIG. 26;

FIG. 31 is front perspective of the busbars and power pins of FIG. 26;

FIG. 32 is a circuit diagram showing details of the bi-directional fusing as referenced in FIG. 3.

### DESCRIPTION OF THE INVENTION

As further shown in the attached figures, the preferred embodiment of the system of the present invention is shown in detail.

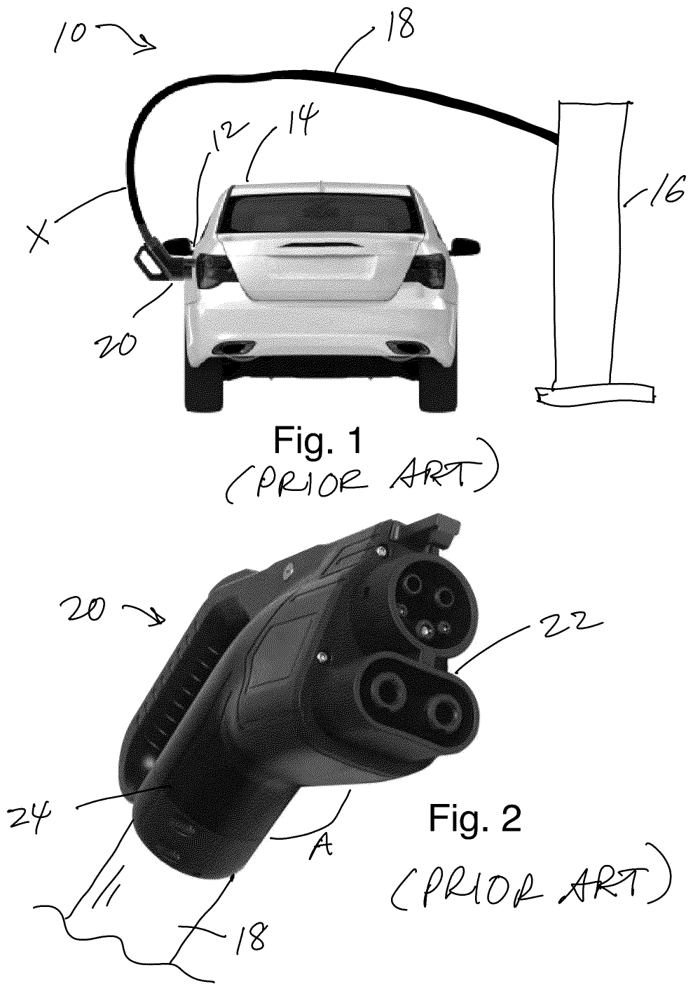

Referring back to FIGS. 1 and 2, discussed above, it can be seen that plugging in a charging cable 18 via an adapter plug 20, when routed over the EV 14, is quite difficult in that the charging port 12 of the EV 14 may end up being located on the opposite side of the vehicle 14 relative to the charging station 16 which presents a more challenging environment 10 to carry out the charging operation, as can be seen in FIG. 1. This environmental arrangement is quite common thus resulting in the charging cable 18 being undesirably outwardly curved or bowed due to the source of the charging cable at the EV charging station 16 being on the opposite side of the EV 14 compared to the charging port 12 on the EV 14 itself. This puts excessive stress and strain at the interconnection of the handle plug 20 with the flexible cable 18 itself resulting in possible damage and excessive wear to the charging cable while making the interconnection difficult to execute.

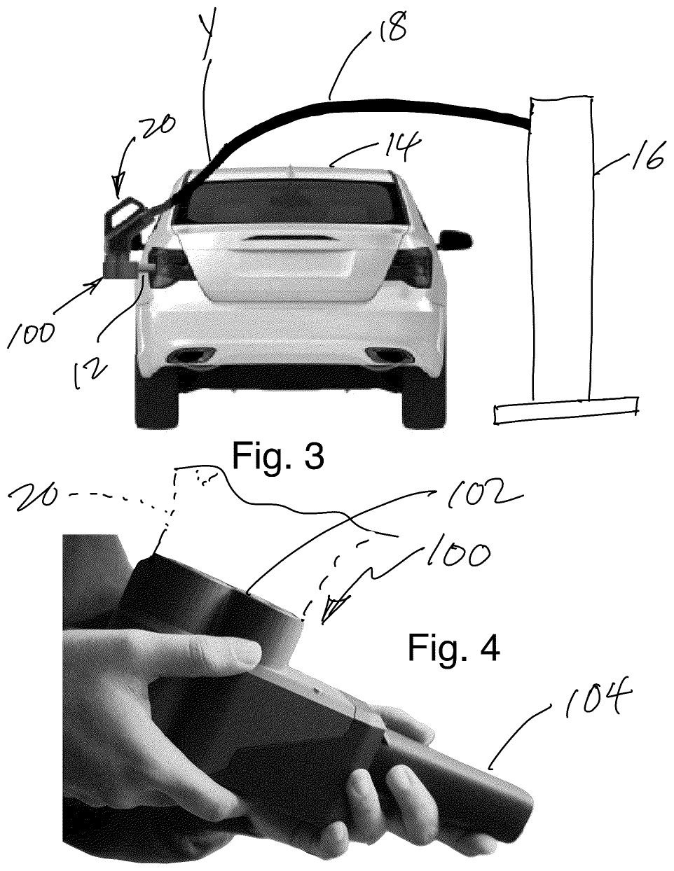

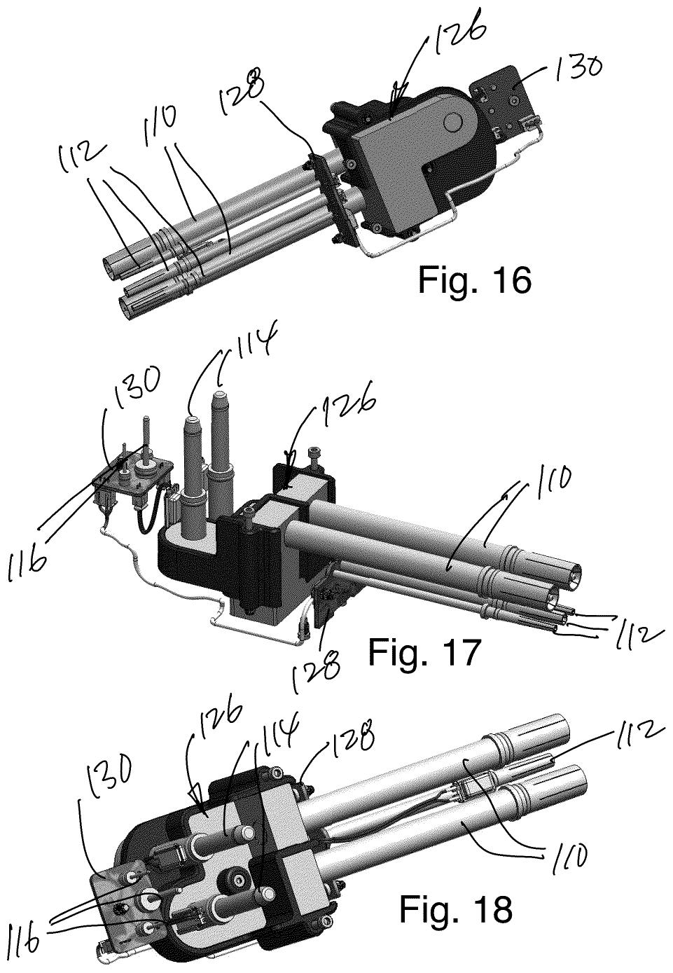

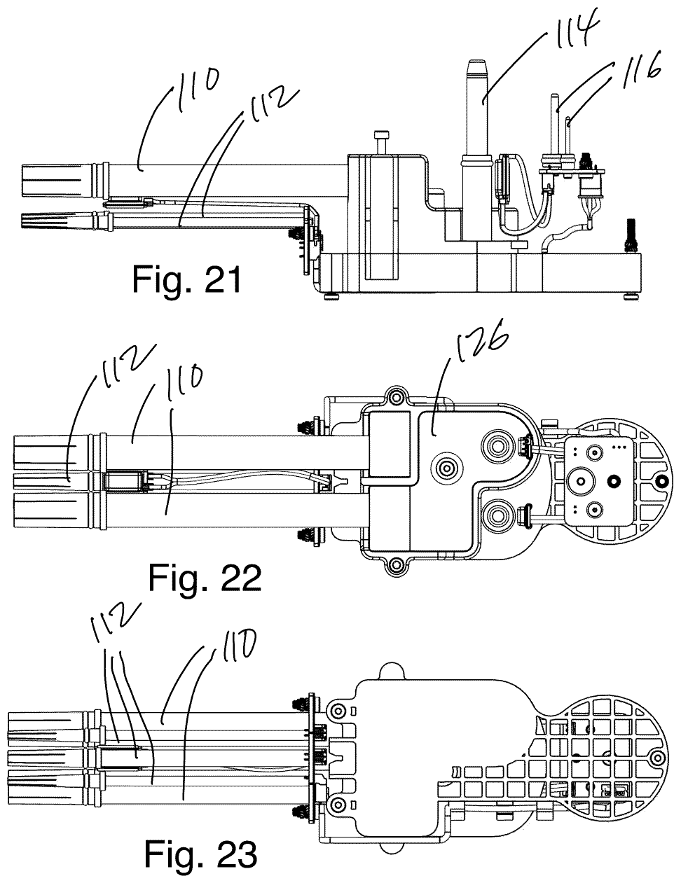

The goal of the present invention to avoid such a stress/strain point X while facilitating the interconnection of the charging cable 18 to the EV 14 by using an angled adapter 100, as seen in FIGS. 3-32. Referring first to FIG. 3, it should be noted that this configuration is just one configuration and environmental arrangement of the EV 14 relative to the charging station 16 that the adapter 100 of the present invention can help the user facilitate the connection of their EV 14 to a charging station 16 for charging of the EV 14. Other configurations are considered to be within the scope of the present invention, such as where the charging station 16 is in the front of the vehicle 14 and charging receptacle port 12 is at the rear of the EV 14, where the charging station 16 is at the rear of the EV 14 and the charging receptacle port 12 is at the front of the EV 14, and the like. All such configurations are considered with the scope of the present invention.

Turning now to FIG. 3, an EV 14 is shown with a charging cable 18 routed from the EV charging station 16 on the opposite side of the vehicle 14 compared to the charging port 12 where the angled adapter 100 is connected between the plug end 20 of the charging cable 18 and the EV charging port receptacle 12. In other words, the angled adapter 100 of the present invention adapts the free end of the plug end 20 of the charging cable 18 so it cuts back toward the vehicle 14, as can be seen in FIG. 3. As a result, the undesirable bowing of the charging cable 18, and the stress associated therewith at location Y, is avoided because the charging cable 18 can now lay in a substantially straight configuration over the vehicle 14 for a stress-free routing back to the charging station 16.

FIG. 4 shows the adapter 100 of the present invention in the hands of a user in preparation for insertion into a receptacle port 12 of an EV 14. The plug end 20 of the charging cable 18 is shown broken lines to illustrate the connection orientation of the plug end 20 of the charging cable 18 into the female end 102 of the angled adapter 100 of the present invention. With the angled adapter 100 connected to the plug end 20 of the charging cable 18, the adapter 100 is inserted directly into the EV 14 via end male plug end 104. Although less desired, it is possible to insert the adapter 100 first into the EV 14 and then connect the plug end 20 of the charging cable 18 into the adapter 100.

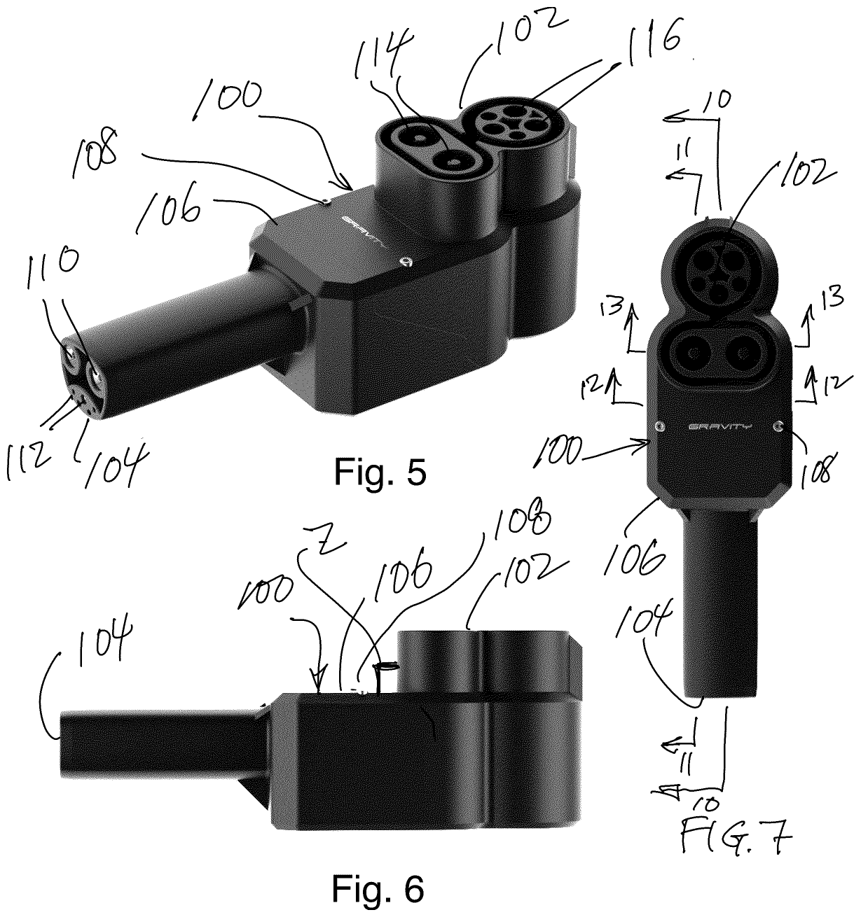

Turning now to the details of the construction of the angled adapter 100 of the present invention, FIG. 5 shows a top perspective view of the angled charging adapter 100 of the present invention with a female CCS 1 DC port 102 on one end and a male NACS port 104 on the opposing end. FIG. 6 is a side elevational view and FIG. 7 is a top view of the adapter 100 of FIG. 5;

Again, it should be noted that different types of ports 102, 104 may be accommodated by the adapter 100 of the present invention and still be within the scope thereof. Different combinations of any type of charging plug 102 and receptacle 104 are envisioned with the scope of the present invention. For example, the adapter 100 of the present invetnion may provide interconnection of the following common standards: CCS to CCS, CCS to NACS, NACS to CCS, NACS to NACS, and the like, but the present invention is not limited to these combinations. The adapter 100 of the present invention can also support SAE J1772 level 2 connector or any other inlet/outlet, whether presently available on the market or not. The adapter 100 may be modified to accomodate a future developed new plug and port standard or to be released at a later time. Therefore, the present invention can accomodate any type of interconnection from the adapter 100 to the EV cable 18 and from the adapter 100 to the charging port 12 itself. While the NACS top CCS DC adapter 100 is shown, it should be understood that the angled charging adapter 100 of the present invention can also be configured for AC chargers and with differently configured plugs 104 and receptacles 102 with cables 108 of any size, including cables 108 that are relatively large.

As can best be seen in FIGS. 5-7, the angled adapter 100 of the present invention includes an outer ruggedized housing 106 with a receptacle port 102 to receive a plug from a charging cable 18 as well as an opposing plug end 104 to be connected to the charging receptacle port 12 of the EV 14. The housing 106 is preferably made of plastic with components fastened together by screws, rivets or the like 108. In general, as seen in FIG. 6, the power pins 110 and signal pins 112 in the male plug end 104 of the adapter are oriented preferably in a 90 degree right angle Z from the power pins 114 and signal pins 116 in the female receptacle end 102 of the adapter 100. However, it should be understood that this angle Z need not be a precise 90 degree angle but may be less than 90 degrees, such as 60 or 75 degrees. Although not preferred, the angle Z may even be more than 90 degrees, such as 100 degrees, depending on the initial angle of approach of a given charging cable 18 and location of the EV charging station 16.

Details of the general purpose and specifications of the power pins 110, 114, and signal pins 112, 116 need not be discussed in detail herein as they are well known in the art. However, as will be discussed in detail below, the adapter 100 of the present invention further includes fusing, possible intercepting of communication over the signal pins for troubleshooting, thermal protection and the like.

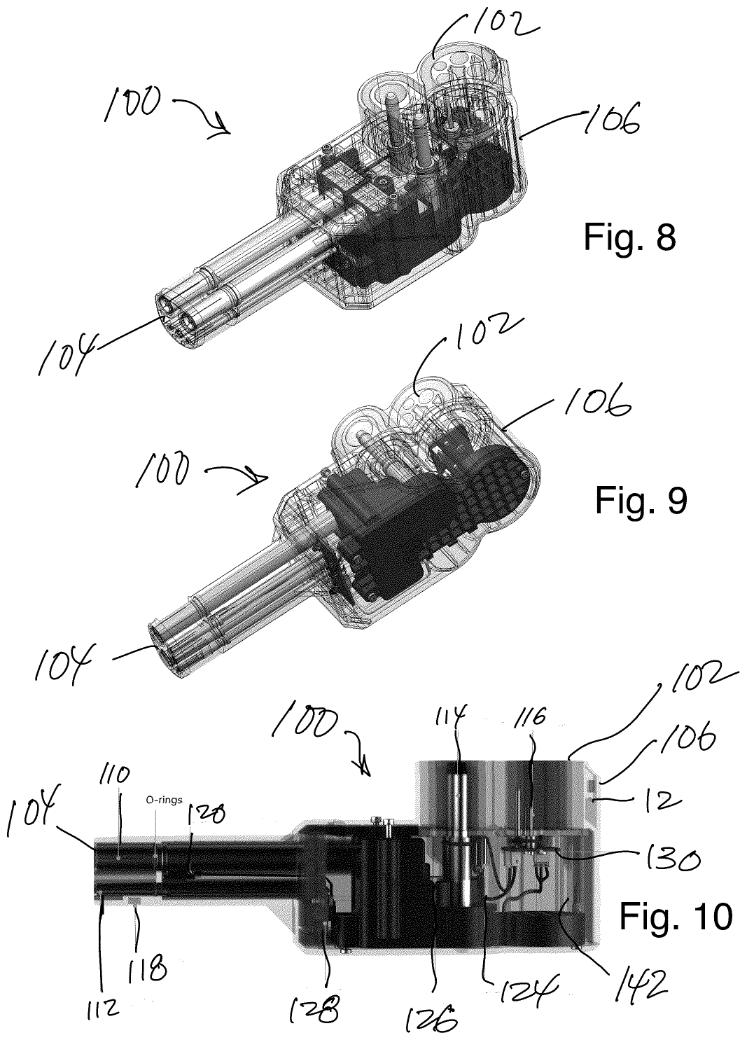

Referring now to FIGS. 8-10, various view of the adapter 100 of FIG. 5 are shown. In FIGS. 8, the outer housing 106 is shown in shadow for illustration purposes. FIG. 10 shows a partial cross-sectional view through the line 10-10 of FIG. 7. In this example, NACS interconnection is provided at the male end 104 of the adapter 100 for interconnection to an EV 14 with an NACS port, such as a Tesla, and the like. On the female end 102 of the adapter 100, CCS interconnection is provided at this female receptacle port side 102 so a charging cable 18 equipped with a CCS male plug 20 on its free ends can be accommodated. Thus, the adapter 100 of the present invention in this example adapts a CCS charging cable 18 to an NACS plug thereby enabling the CCS equipped charging station 18 to charge a NACS equipped EV 14. For example, the adapter 100 is prefereasbly compatible with CCS enabled Tesla EVs so such Tesla Evs can be charged using a CCS charging station 18 with the assistance of the present adapter.

The adapter 100 of the present invention includes various components enclosed within the housing 106. On the male plug end 104 of the adapter 100, the NACS power pins 110 and NACS signal pins 112 are provided with an NACS passive latch 118 and thermal cutoff switch 120. On the receptacle port side 102 of the adapter 100, CCS power pins 114 and CCS signal pins 116 are provided with a CCS passive latch 122 and CCS thermal cutoff switch 124. Copper busbars 126 interconnect the NACS side power pins 110 to their respective CCS side power pins 114. The signal pins 112, 116 are preferably interconnected by wires. The busbars 126 for interconnection of the power pins 110, 114 in the small housing 106 of the adapter 100 of the present invention eliminates the need to bend cable, for example. Printed circuit boards (PCBs) 128, 130 are provided for both the NACS pins 112 and the CCS pins 116, respectively. Details of the location and function of the PCBs 128, 130 and busbars, collectively 126, are discussed in detail below.

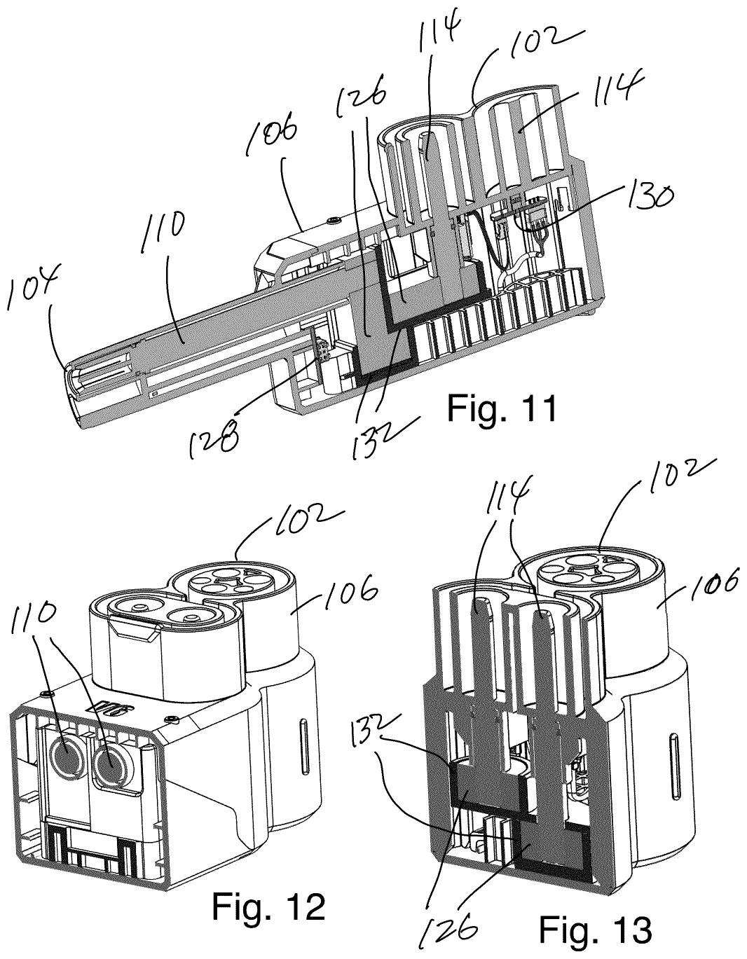

FIGS. 11-13 provide various cross-sectional views through FIG. 7 to further illustrate the various components of the adapter 100 of the present invention. For example, FIG. 11 shows a cross-section through line 11-11 of FIG. 7 which is lengthwise through the power pins 110, while FIG. 12 shows a cross-sectional view through the line of 12-12 of FIG. 7 which is a transverse cross-section through both power pins 110 on the plug end 104 and FIG. 13 which shows a cross-sectional view through the line 13-13 of FIG. 7 which is a transverse cross-section through both power pins 114 in the receptacle port end 102 of the adapter 100. In FIGS. 11 and 13, the electrically conductive busbars 126 can be seen with insulative material 132 residing therebetween to electrically respectively isolate the current flow between the various sets of power pins 110, 114 and signal pins 112, 116. In this preferred embodiment, these busbars preferably provide 90 degree translation of the direction of the current flow path between the vertically oriented CCS power pins 114 and the horizontally oriented NACS power pins 110. In FIG. 11, the circuit board 128 for the NACS pins can be seen inside the left side of the housing 106 and the circuit board 130 for the CCS pins can be seen inside the right side of the housing 106.

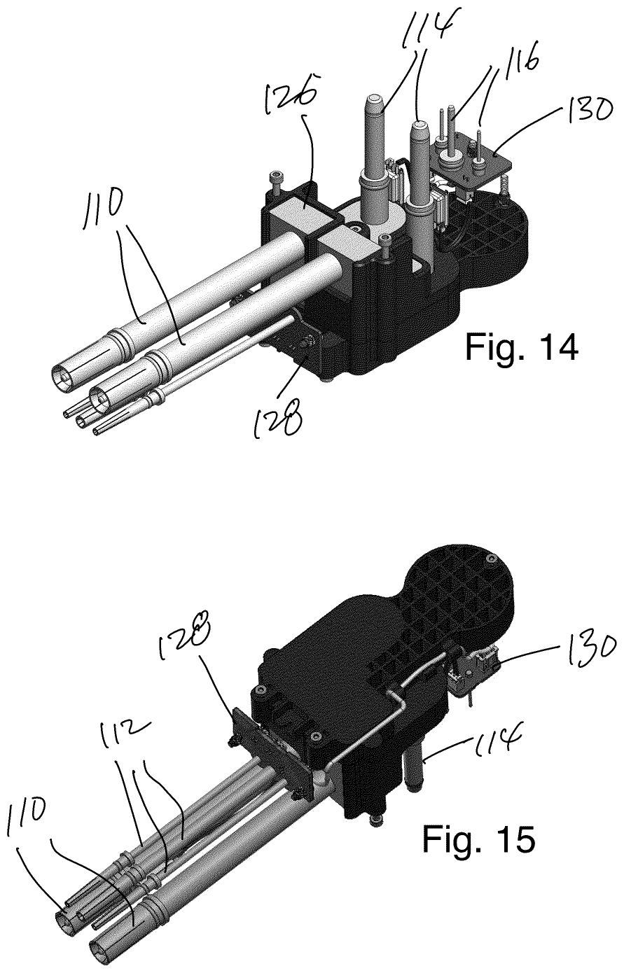

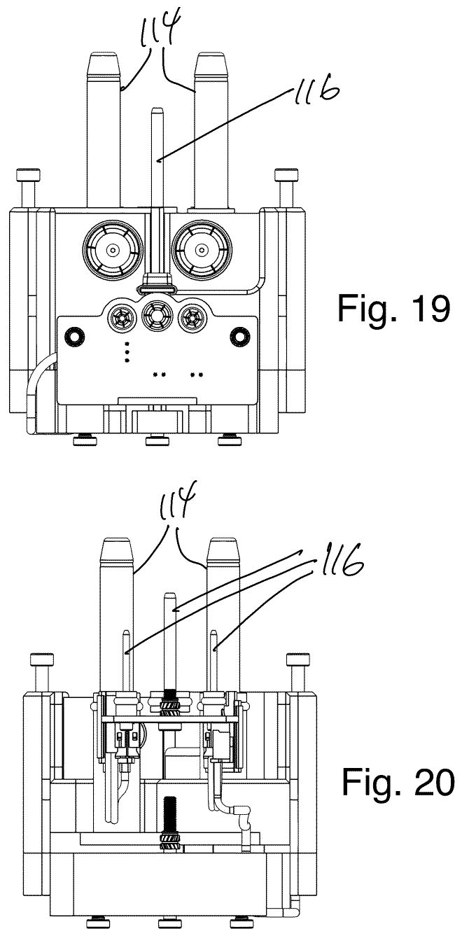

In FIGS. 14-18, the busbars 126 and the circuit boards 128, 130 for the CCS and NACS pins can be seen in further detail. To fully illustrate the location of the busbars 126 and circuit boards 128, 130, multiple perspective views of the adapter 100 in FIGS. 14-18 are shown with the outer housing 106 removed for illustration purposes. FIGS. 19-23 show various elevational views to even further illustrate the various components of the adapter 100 and how where they are located within the adapter 100.

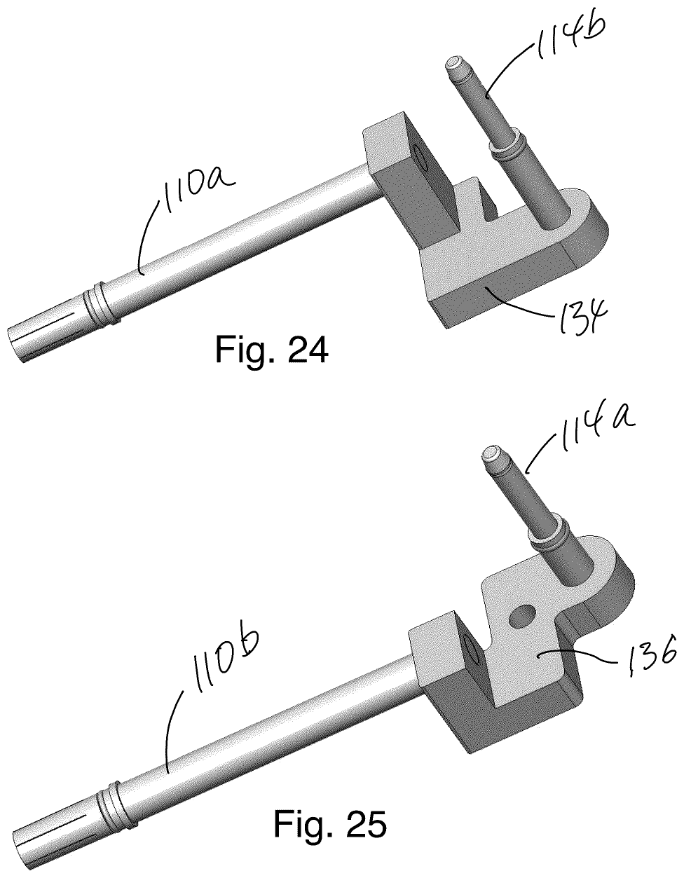

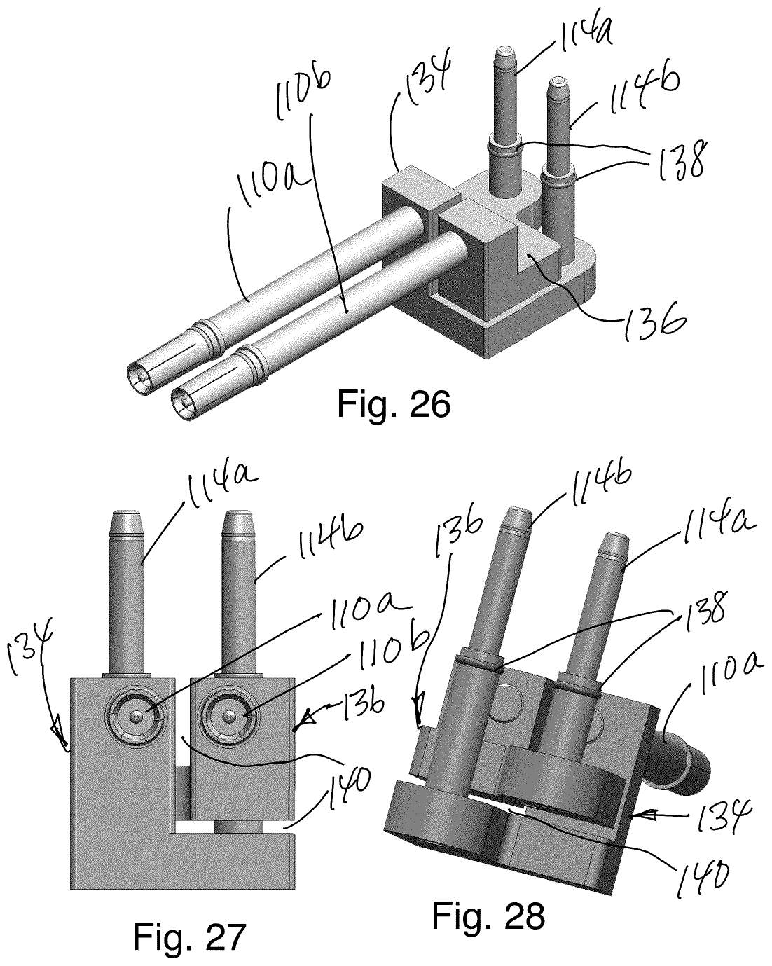

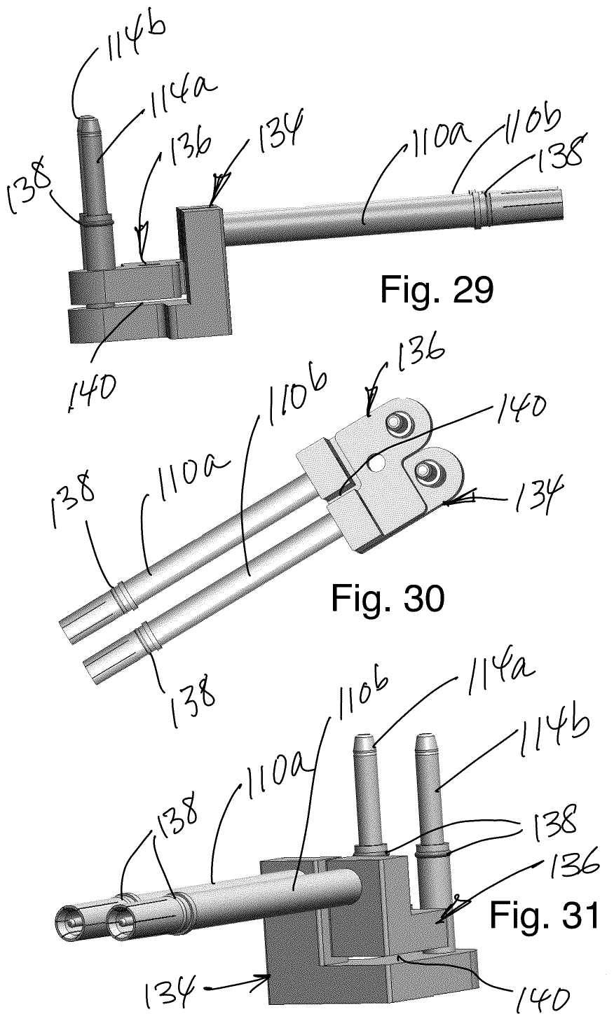

Referring now to FIGS. 24-31, various views of the power pins 110, 114 and their interconnecting busbars 134, 136 are shown in detail. More specifically, in FIG. 24, a first busbar 134 is provided to electrically connect the left power pin 110a on the left NACS side to the right power pin 114b on the right CCS side. In FIG. 25, a second busbar 136 is provided to electrically connect the right power pin 110b on the left NACS side to the left power pin 114a on the right CCS side. In FIG. 26, busbar arrangement 136 of FIG. 25 is shown nested on top of the busbar arrangement 134 of FIG. 24. Gaskets 138 are provides for interfacing to the outer housing structure 106. While not shown in FIGS. 24-31, insulative material 132 resides within any gaps 140 between the two respective busbars. FIG. 27 shows a front view of the assembled busbars 134, 136 to provide the two NACS power pins 110a, 110b beside each other and extending laterally while the two CCS power pins 114a, 114b are provided beside each other and extending upwardly. FIG. 28 shows a perspective view to show a gap 140 between the two busbars 134, 136, which is later occupied with insulative material 132, as described above. FIG. 29 shows a side elevational view to illustrate another gap 140 between the two busbars 134, 136, which is also occupied by insulative material 132. FIG. 30 shows a top perspective view to further illustrate the interlocking L-shaped busbars 134, 136 and another gap 140 therebetween which is occupied by insulative material 132. FIG. 31 provides another perspective view to illustrate yet another gap 140 between the two busbars 134, 136, which is also occupied by insulative material 132. Such insulative material 132 may be plastic, foam or any other type of insulative material that is suitable for isolating electric current flow through the respective busbars 134, 136.

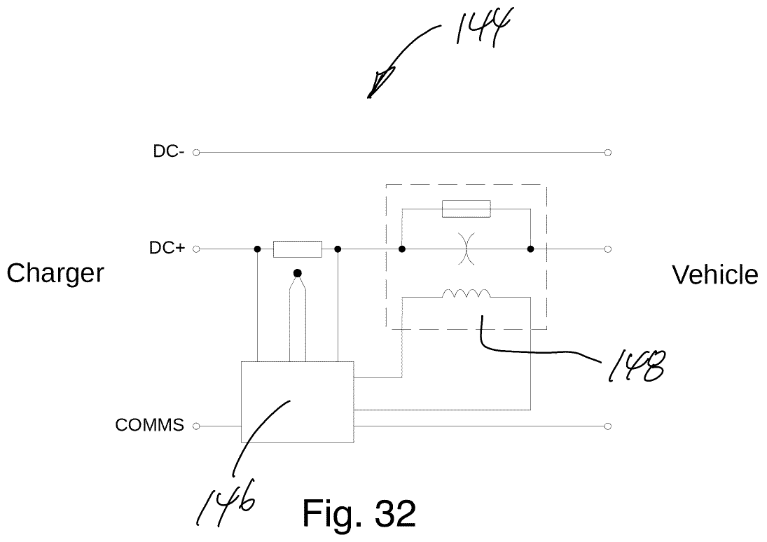

Referring back to FIGS. 14-18, the circuit boards 128, 130 may be configured and arranged so it may be used as an interface to “sniff” or intercept, i.e., monitor, the communication data over the communication lines between the respective signal pins 112, 116 for troubleshooting, and the like. Moreover, also via the circuit boards 128, 130, the adapter 100 has a built-in thermal protection circuit for mapping of the charging pin temperatures. The circuits within the adapter 100 preferably have a primary and a backup thermal measurement system to build redundancy and robustness for thermal cutoff. Also, the adapter 100 is preferably configured for high-speed charging and conducting 500A continuously for 30 minutes without breaching safe surface temperature limits. The adapter 100 of the present invention may also be configured with a fuse so that when sending power back from the vehicle 14 there is protection near the vehicle inlet (as required by UL), as shown representationally in the housing as 142 in FIG. 10, for example. Moreover, the adapter 100 of the present invention may be configured to accomodate uni-directional and/or bi-directional charging cables 18 for broad compatibility and interoperability between Evs 14 and charging stations 16. Referring now to FIG. 32, example circuitry 144 is provided by the circuit boards 128, 130 within the adapter 100 to provide a controller 146 and pyrofuse 148 and other circuitry for the aforesaid monitoring and measuring capabilities of the adapter 100. The use of a pyrofuse 148 provides compliance with the safety requirements for providing bidirectional EV charging.

It should be understood that such circuit sniffing/monitoring and thermal measurement systems are generally known in the art so that they need not be discussed in detail herein. However, the present invention unquely provides for such measurement monitoring and measurement systems in an angled adapter configuration.

Also, materials are preferably selected that make it easier to plug in the adapter 100 to an EV 14 and into the plug 20 of the charging cable 18. Also, the present invention provides a quick release/breakaway option so that the adapter 100 will break apart in an emergency situation where, for example, there is a need to drive away with the charging cable 18 still plugged into the EV 14. For example, if the user is sitting in the EV 14 and a stranger tries to enter the vehicle 14 without permission, the user can avoid getting out of the EV 14 to manually disconnect the charging cable, which would present a dangerous situation, and then simply drive off where the breakaway feature would permit such quick escape. For example, the busbar would be designed to include a high current connector in the current path that will break apart if the car is driven away. The connectors would be located near the weakest points in plastic housing so that the assembly is able to break open. The adapter will undergo permanent damage in this process.

In summary, the adapter 100 of the present invention is preferably configured to adapt between CCS1 to NACS but the adapter 100 may be modified to suit other combinations of standards. The dimensions are preferably 10″ in length×4″ in width×3″ in height. The maximum current is preferably 500A continuous for 30 minutes before reaching 60C surface temperature with a voltage up to 1000V and thermal protection in the form of at least two thermal switches, such as up to four switches depending on space inside the adapter 100. The weight of the adapter 100 is approximately 1 kg but may be heavier or lighter in weight depending on the components included in the given configuration. The adapter 100 is preferably rated for at least IP55. The operating temperature ranger of the adapter is −30C to 50C and includes passive cooling.

Therefore, an angled adapter 100, for example a right-angle adapter, which allows EV charging cables 18 to not to protrude horizontally (often into the street) when connected, is provided by the present invention. The unique angled charging adapter 100 of the present invention is critical for curbside charging and especially, for example, where parallel parking results in the the charge port 12 being on the driver side and opposition to the EV charging station 16 itself.

The aforesaid examples are only one of the optimal modes of execution of the present invention and common changes and substitutes made by technical personnel of this field within the technical proposal of this invention should be included in the protection scope thereof. It would be appreciated by those skilled in the art that various changes and modifications can be made to the illustrated embodiments without departing from the spirit of the present invention. All such modifications and changes are intended to be covered by the appended claims.

What is claimed is:

1. An angled adapter for an electric vehicle charging cable, comprising:
a housing having a first end and a second end; the first end being disposed at an angle relative to the second end;
first and second power pins in the first end and first and second power pins in the second end;
a first electrical busbar electrically connecting the first power pin in the first end with the second pin in the first end;
a second electrical busbar electrically connecting the first power pin in the second end and the second power pin in the second end;
wherein an electric vehicle charging cable is configured and arranged to reside between and be in electrical communication with the charging cable and the electric vehicle with the adapter altering an angle interconnection of the charging cable relative to the electric vehicle.

2. The angled adapter of claim 1, wherein the angled adapter enables charging connectivity of a charging cable from a charging station on a first side of an electric vehicle to a charging port of an electric vehicle on a side other than the side where the charging station is located, whereby the charging cable is more easily plugged into the electric vehicle with reduced strain on the charging cable.

3. The angled adapter of claim 1, wherein the first end and the second end of the adapter is configured and arranged to be of a standardized connector selected from the group consisting of CCS to CCS, CCS to NACS, NACS to NACS, and NACS to CCS.

4. The angled adapter of claim 1, wherein circuitry is provided to configure the adapter with a symmetric and/or asymmetrical fuse.

5. The angled adapter of claim 4, wherein the fuse is a pyrofuse.

6. The angled adapter of claim 1, wherein the adapter includes a quick disconnect release.

7. The angled adapter of claim 1, wherein the angle is approximately 90 degrees.

8. The angled adapter of claim 1, further comprising electrically interconnected signal pins in each of the first end and the second end; wherein circuitry in communication with the the signal pins provides an interface for monitoring communication lines in the adapter.

9. The angled adapter of claim 1, further comprising circuitry configured and arranged for providing built-in thermal protection and mapping of chargin pin temperatures and for measuring temperature; wherein redundancy and robustness for thermal cutoff is provided.

10. The angled adapter of claim 1, wherein the adapter is configured and arranged for high-speed charging at 500 amps for 30 minutes without breaching safe surface temperature limits.
